(19) United States
(12) Patent Application Publication
(10) Pub. No.: US 2003/0145131 A1
(43) Pub. Date: Jul. 31, 2003

(54) SCSI-message parity error handling during data phase

(76) Inventors: Simon Pelly, Bristol (GB); Neil Johnson, Bristol (GB)

Correspondence Address: LOWE HAUPTMAN GILMAN & BERNER, LLP, Suite 310, 1700 Diagonal Road, Alexandria, VA, 22314, US

(21) Appl. No.: 10/060,057

(22) Filed: Jan. 31, 2002

(51) Int. Cl. G06F 9/00; G06F 9/46

(52) U.S. Cl. 709/326

(57) ABSTRACT

There is disclosed a method and apparatus for affecting recovery from an inappropriate message received on a SCSI bus, immediately after a data transfer phase. Where a message parity error message is received by a SCSI peripheral device immediately after a data transfer phase, or interrupting a data transfer phase, the peripheral device recognizes the message parity error message as a no-operation message, and re-initiates a full data transfer from the host device.

### FIELD OF THE INVENTION

The present invention relates to the field of computers and particularly, although not exclusively to a small computer system interface (SCSI) connection between two or more computer entities.

### BACKGROUND TO THE INVENTION

The small computer system interface (SCSI) is well known to those in the art of computer science and comprises a protocol for allowing communication between a plurality of computer entities, for example a host computer and one or more peripheral devices. There are many types of host computer device known in the art and also many types of peripheral devices known in the art which can communicate with each other via the known SCSI interface.

The SCSI specification (ANSI Standard X3.131-1986) defines a high perform peripheral interface which distributes data among peripherals independently of a host computer, thereby freeing a host computer for more user oriented activities. The specification for SCSI can be obtained from American National Standards Insitute, 1430 Broadway, New York 10018.

Referring to FIG. 1 herein, there is illustrated schematcally a host computer 100 connected via a SCSI bus to a plurality of tape drive data storage devices 101.

Referring to FIG. 2 herein, there is illustrated schematically a logical diagram of the arrangement of FIG. 1. Host computer 200 communicates with a plurality of tape drive data storage back-up devices 201-203 via a SCSI bus 204.

Each device has a SCSI driver. Host computer 200 has a host driver, whereas each peripheral device 201-203 has a peripheral device SCSI driver.

In the particular example of a Hewlett Packard UX type host device, communicating with a tape drive data storage back-up peripheral, via a SCSI interface, there has been experienced the particular problem that hangs of the SCSI interface may occur, even when the behavior of two or more tape drive units 201-203 and the host computer is perfectly legal, i.e. within the SCSI specification.

Host computers which obey the SCSI specfication should not send a message parity error (MPE) message during a SCSI data phase. However, if a message parity error were to be sent during a SCSI data phase by a host computer, then this must be handled in some way by a peripheral device receiving the message parity error.

The known SCSI specification does not detail how such an message parity error message received during a SCSI data phase should be handled by a receiving peripheral device.

### SUMMARY OF THE INVENTION

According to one aspect of the present invention there is provided a method of operation of a SCSI enabled device, said method comprising the steps of:

receiving a message parity error message over a SCSI bus;

determining whether said SCSI enabled device is in a data transfer state;

if said SCSI enabled device is in a data transfer state, then generating a response message to an initiator, said response message notifying said initiator device that a previous data transfer operation will be resumed.

According to a second aspect of the present invention there is provided a method of operating a SCSI driver, said method comprising the steps of:

carrying out a data transfer phase;

receiving a message parity error message following said data transfer phase; and

sending a restore data pointer message, after receiving said message parity error message.

According to a third aspect of the present invention there is provided a SCSI enabled device, comprising:

means for receiving a message parity error message over a SCSI bus;

means for determining whether said SCSI enabled device is in a data transfer state; and

means for generating a response signal to an initiator device from which a data transfer phase was initiated, said response message notifying said initiator device that a previous data transfer operation will be recommenced.

According to a fourth aspect of the present invention there is provided a SCSI driver comprising:

means for carrying out a data transfer phase;

means for receiving a message parity error message following said data transfer phase;

means for recognising that a message parity error message has occurred immediately after a data transfer phase; and

means for sending a restore data pointer message, after receiving said message parity error message.

According to a fifth aspect of the present invention there is provided program data for instructing a processor to perform SCSI operations comprising:

determining whether a SCSI message parity error message has been received;

determining whether said device is in a data transfer state;

if said device is in data transfer state, generating a response message, said response message for notifying a SCSI initiator device that a previous data transfer operation is to be recommenced.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 illustrates schematically the general arrangement of a host computer connected to a peripheral tape data storage device via a SCSI bus as is known in the prior art;

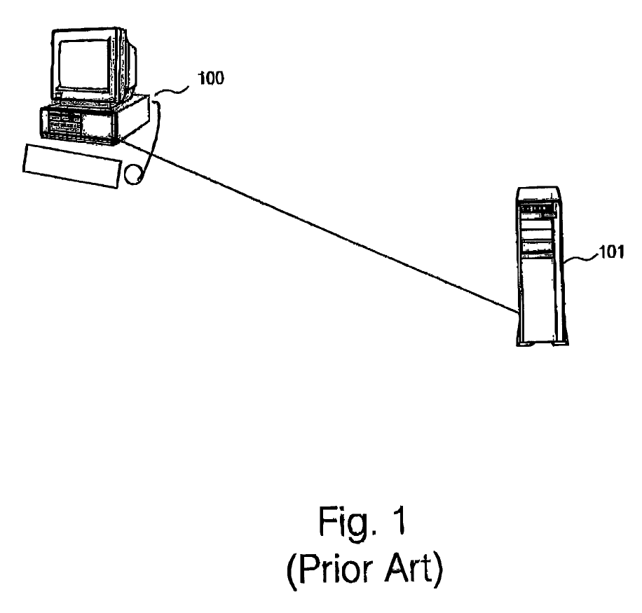

FIG. 2 illustrates schematically a logical view of the arrangement of FIG. 1 illustrating a host computer device and a plurality of peripheral computer devices connected to a SCSI bus as is known in the prior art;

FIG. 3 illustrates schematically components of a SCSI enabled peripheral tape data storage device according to specific implementation on the present invention;

FIG. 4 illustrates schematically a SCSI signaling sequence according to a specific implementation on the present invention;

FIG. 5 illustrates schematically processes carried out at a SCSI peripheral driver for recognizing a message parity error message after a date transfer phase, and for sending a response to a host computer; and

FIG. 6 illustrates schematically a process that is carried out at a peripheral device for constructing a response to a message parity error message signal received after a data transfer phase.

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

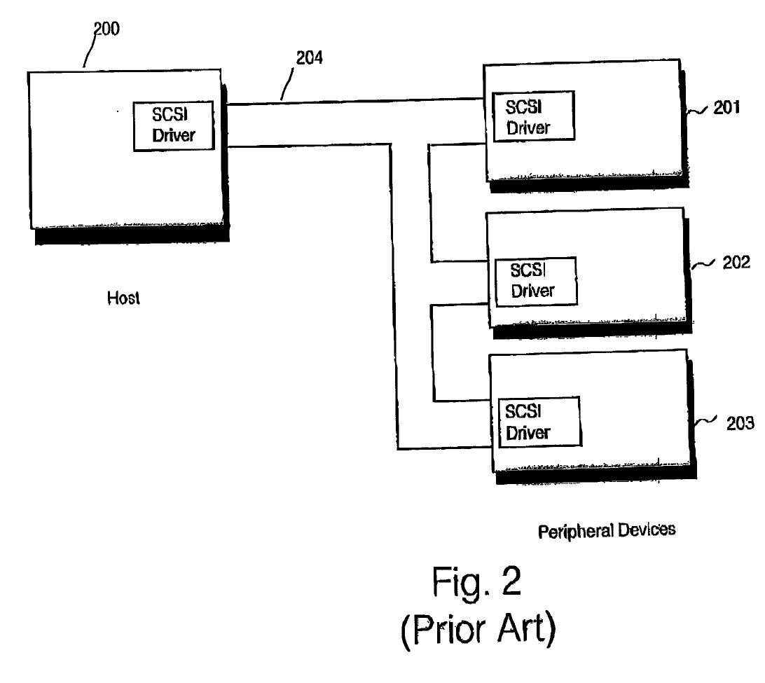

In the following description, a problem with the prior art host computer and host SCSI driver and prior art peripheral tape data storage device and peripheral driver according to FIG. 2 is described.

In the known SCSI protocol, a host device is permitted to send message bytes during a data transfer phase. Some messages are meaningful and they occur during a data transfer. However, other types of messages are meaningless and inappropriate when they occur during a data transfer phase.

Normally, messages sent during a data transfer phase would be messages which are appropriate, i.e. have a meaning in the context of the data transfer phase. Ideally, messages of a meaningless or inappropriate type would not be sent during a data transfer phase by an interior host computer device. However, in practice, meaningless and/or inappropriate messages do occur during data transfer phases and are sent by host computer devices onto a SCSI bus.

To avoid crashes or hangs of a SCSI peripheral device upon receiving an inappropriate message, the device needs to be able to recognize inappropriate messages and have a response mechanism for dealing with inappropriate messages received during a data transfer phase.

An example of an inappropriate message which could be received during a data transfer phase comprises a parity error message during a SCSI data phase. A message parity error message (MPEM) indicates to a driver that there has been some kind of parity error detected during a message phase. This would be inappropriate immediately after a data transfer, because the message parity error message relates to a message, whereas the last set of signals on the SCSI bus were data transfer, not messages. Therefore, in that context, the message parity error message is meaningless. It is inappropriate to send the message parity error message to a SCSI bus, when there has been no message to which that message parity error message relates.

In the environment of a tape data storage device, where data transfers between a host computer and a tape data storage device are transfers of user data to be backed up, the appearance of an inappropriate message phase immediately after a data transfer can cause the tape data storage device to crash, or a whole data back up operation could be terminated and back up restores could fail. This is clearly a serious disadvantage in a back up tape data storage system.

In the best mode implementation, there is provided a component of a SCSI driver, which is capable of recognizing inappropriate message phases received immediately after a data transfer phase, and of making responses to those inappropriate messages, without causing a crash or hang of the SCSI driver.

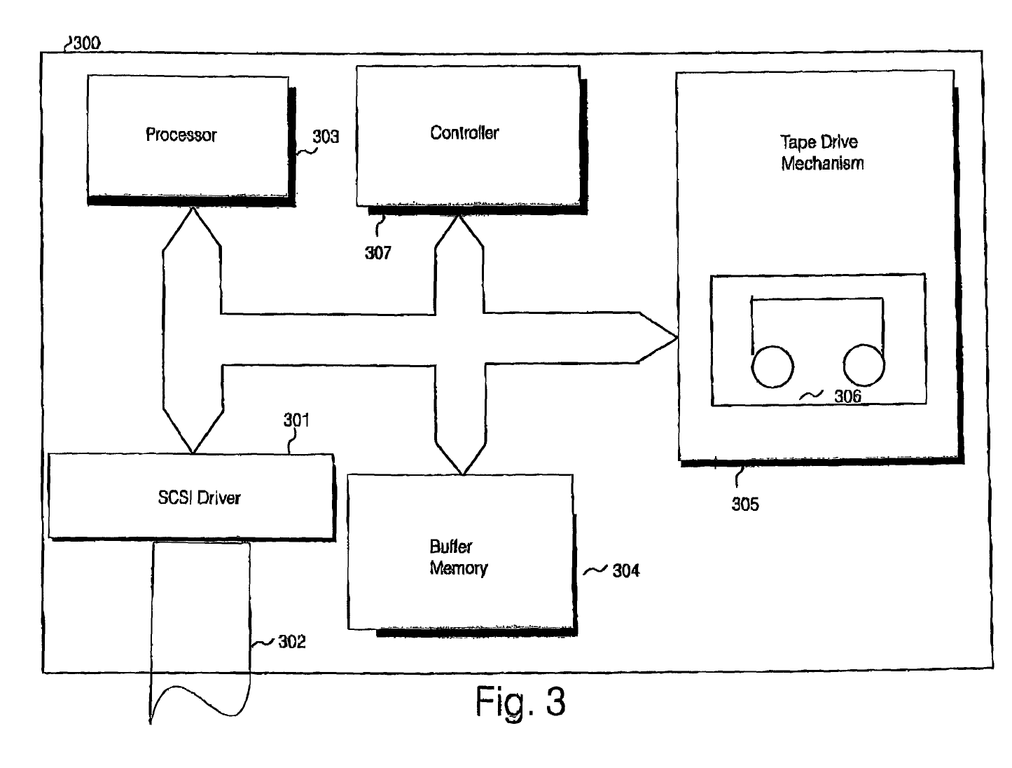

Referring to FIG. 3 herein there is illustrated schematically components of a tape data storage device. The tape data storage device 300 comprises a SCSI interface 301 capable of communicating with a SCSI bus 302; at least one data processor 303; a buffer memory 304; a tape drive mechanism 305 having a port for accepting a removable tape data storage medium 306. A controller 307 for controlling input of data through the SCSI interface 301, controlling and managing data storage in the buffer memory 304; and controlling data storage and management in the tape drive mechanism 305. The tape data storage device also comprises power supply, liquid crystal display for showing an operational status of the data storage device as is known in the prior art.

Within the controller 307 is stored an algorithm in the form of stored program data for operating the tape drive mechanism, buffer memory, processor 303 and SCSI interface 301.

Controller 307 contains program data written in the conventional program language for example C, or C++ as is known to those skilled in the art. The program data comprises an algorithm for causing the SCSI enabled peripheral device to operate in modes of operation as follows.

There will now be described operation of a tape data storage device for overcoming the problem of hangs caused under conditions in which a host computer device seizes a SCSI bus during a bus free period after an arbitration host selection period and commend write/read period.

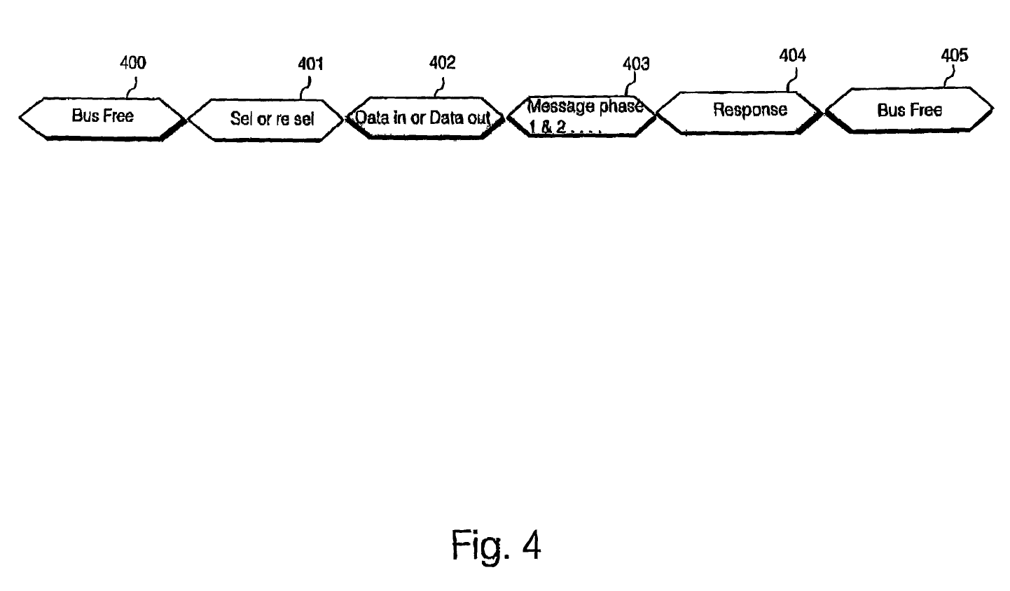

Referring to FIG. 4 herein, there is illustrated schematically a signal sequence on a SCSI bus received by a SCSI enabled peripheral device, which may give rise to an inappropriate message, causing a hang or crash of the peripheral device. A bus free phase 400 occurs followed by a select or re-select phase 401 for selecting or re-selecting a device; a data in/out phase 402 for transferring data between a host initiator and a peripheral target; a message phase 403 containing a message parity error message; a response phase 404 containing a response signal from a device receiving the message parity error message; and a bus free period 405 after the response period.

The message parity error message is a message generated by an initiator and which is sent to a target device to indicate that one or more bytes in the last message it received had a parity error.

One solution would be to replace the host driver, with a new driver which does not arbitrate to a peripheral, immediately after an arbitration host selection process and command write/read phase. However, in practice there are a large number of legacy host drivers in existence and replacing all these host drivers with modified host drivers is not practical. Therefore, a modification of the peripheral device is preferred.

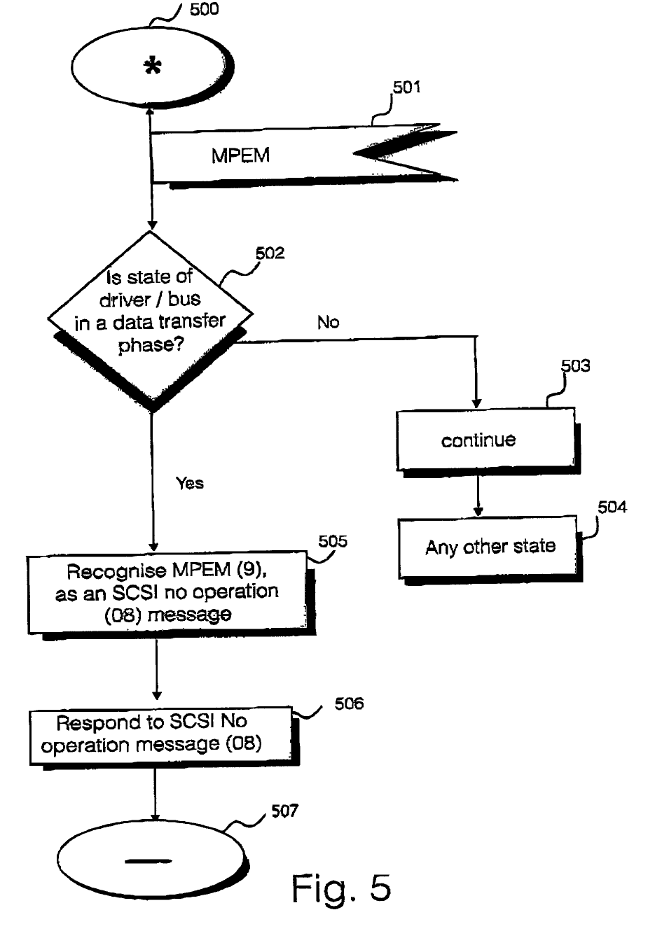

Referring to FIG. 5 herein there is illustrated schematically process steps carried out by SCSI driver, upon receiving a message parity error message (MPEM) immediately after data transfer phase. The SCSI driver is in an initial state 500, which can be any state. A message parity error message 501 is received on the SCSI bus. Upon receiving the message parity error message, the SCSI driver checks whether the state of the driver is in a data transfer phase in process 502. If the SCSI driver is not in a data transfer phase, then in process 503, the SCSI driver continues to respond to the message parity error message in conventional manner and then reverts to any other state 504. However, if in process 502 the state of the driver immediately before receipt of the message parity error message was a data transfer state, then in process 503 the SCSI driver recognizes the message parity error message as being a SCSI no-operation message. In process 504, the SCSI driver responds to the message parity error message by making a response to a no-operation message, and then reverts to a previous state 504.

As SCSI no-operation message is a message which an initiator device sends to a target device, when the target is requesting a message and the initiator does not have any other valid message to send. In other words, the no-operation message is simply a message which is sent by a host computer to a peripheral, to ignore the message.

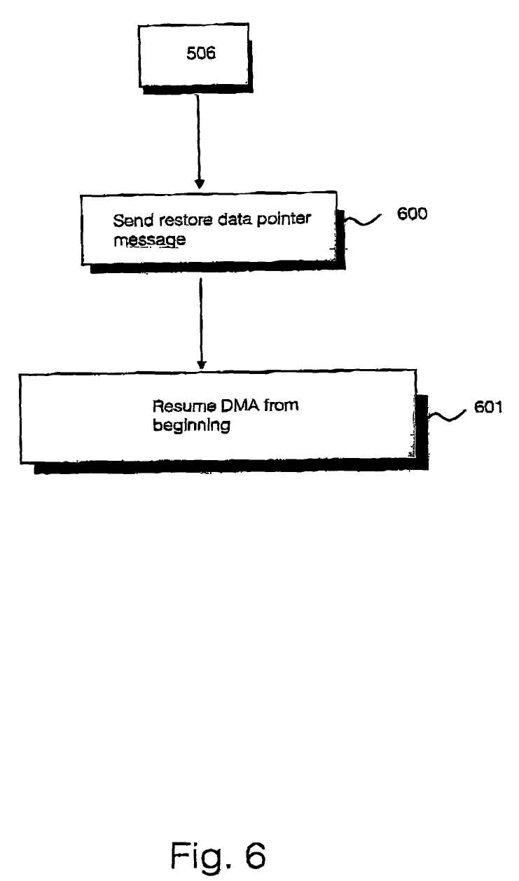

Referring to FIG. 6, there is illustrated schematically process steps carried out by the peripheral driver to implement a response in process 506. Firstly, in process 600 the peripheral driver sends a rare data pointer message back to the host computer, which informs the host computer that the peripheral driver is going to re-try the whole of the data transfer phase from the beginning. In process 601, the peripheral device resumes the data transfer from the beginning.

The data transfer is resumed at the host from the beginning, rather than from any point at which the data transfer was interrupted.

When the message parity error message is received, the peripheral drive is effectively in control of the SCSI bus. The message parity error message is received during a direct memory access phase (DMA) in which a host I/O sub-system transfers data to and from a memory sub-system in the peripheral without processor intervention. Therefore, a buffer in the host computer is effectively synchronized with the buffer in the peripheral device, and synchronization between the two buffers needs to be maintained. In order to maintain synchronization between the host buffer and peripheral buffer, it is more effective to re-start the whole data transfer operation, than it is to implement a recovery of the data transfer operation from a point of failure.

Implementation of the above specific methods may have an advantage of maintaining connectivity between a host computer and a peripheral tape data storage device under conditions of inappropriate messages following a data transfer phase.

Modification may be made to a prior art peripheral device having a prior art SCSI driver, to upgrade the prior art device to a device enabled to implement the present invention by several ways.

Firstly, a driver component according to a specific implementation of the present invention may be stored on a tape data storage media, which is inserted into a tape drive mechanism and read from the tape drive mechanism into a memory of the tape data storage device, to become part of the controller 307.

Secondly, program data can be sent from a host computer to the peripheral tape data storage device for storage into the local controller of the data storage device, where the program data comprises a complete replacement driver or a patch to an existing legacy SCSI driver. In either case, the replacement driver or patch comprises a component for effecting operation of the peripheral device according to the specific methods of the present invention. The replacement driver or patch may be stored on a data storage media, such as for example a CD-ROM and loaded into the host computer before being sent to the peripheral computer over the SCSI bus.

The program data is sent with a sequence of commands to the peripheral tape data storage device, which the peripheral tape data storage device uses to recognize the program data as an upgrade.

Thirdly, program data comprising a replacement SCSI driver or a patch to an existing SCSI driver may be input via a serial port of the tape data storage device.

The program data is stored in flash EEPROM within the tape data storage device. Hard wiring of the tape data storage device is not altered, however a program data image stored in the flash EEPROM may be modified, in order to implement specific methods according to the invention.

It will be understood by those skilled in the art that alternative implementations are possible, although not necessarily optimal. For example, the specific embodiments of the present invention may be implemented as an application specific integrated circuit contained within a tape data storage device. However, this implementation may be non-optimal, due to the difficulty in upgrading or modifying the implementation after manufacture.

1. A method of operation of a SCSI enabled device, said method comprising the steps of:
receiving a message parity error message over a SCSI bus;
determining whether said SCSI enabled device is in a data transfer state;
if said SCSI enabled device is in a data transfer state, then generating a response message to an initiator, said response message notifying said initiator device that a previous data transfer operation will be recommenced.

2. The method as claimed in claim 1, wherein said response message notifies said initiator device that said data transfer operation will recommence from the start of said data transfer operation.

3. A method of operating a SCSI driver, said method comprising the steps of:
carrying out a data transfer phase;
receiving a message parity error message following said data transfer phase; and
sending a restore data pointer message, after receiving said message parity error message.

4. The method as claimed in claim 3, comprising the step of:
sending a message instructing recommencing said data transfer phase after sending said restore data pointer message.

5. A SCSI enabled device, comprising:
means for receiving a message parity error message over a SCSI bus;
means for determining whether said SCSI enabled device is in a data transfer state; and
means for generating a response signal to an initiator device from which a data transfer phase was initiated, said response message notifying said initiator device that a previous data transfer operation will be recommenced.

6. A SCSI driver comprising:
means for carrying out a data transfer phase;
means for receiving a message parity error message following said data transfer phase;
means for recognising that a message parity error message has occurred immediately after a data transfer phase; and
means for sending a restore data pointer message, after receiving said message parity error message.

7. The SCSI driver as claimed in claim 6, wherein said driver operates to send a message for recommencing said data transfer phase after sending said restore data pointer message.

8. Program data for instructing a processor to perform SCSI operations said operations comprising:
determining whether a SCSI message parity error message has been received;
determining whether said device is in a data transfer state;
if said device is in data transfer state, generating a response message, said response message for notifying a SCSI initiator device that a previous data transfer operation is to be recommenced.

9. The program data as claimed in claim 8, stored on a program data storage media selected from the set;
a CD-ROM;
a magnetic data storage medium.
